(19) United States
(12) Patent Application Publication
(10) Pub. No.: US 2023/0214461 A1
(43) Pub. Date: Jul. 6, 2023

(54) SYSTEM AND PROCESS FOR GENERATING CODE SNIPPETS TO LICENSE DIGITAL CONTENT

(71) Applicant: ESPAT Media Group, Inc., Long Beach, NY (US)

(72) Inventor: Edward J. Brooks, Long Beach, NY (US)

(21) Appl. No.: 18/149,058

(22) Filed: Dec. 30, 2022

Related U.S. Application Data
(60) Provisional application No. 63/295,246, filed on Dec. 30, 2021.

(51) Int. Cl. G06F 21/10; G06Q 30/0601

(52) U.S. Cl. CPC G06F 21/105; G06Q 30/0641

(57) ABSTRACT

A method and system for generating code snippets to license content are disclosed. In some embodiments, the method includes acquiring a digital asset in a software-as-a-service (SaaS) interface. The method further includes generating metadata and an access uniform resource locator (URL) for the digital asset. The method additionally includes generating a primary JavaScript object notation (JSON) file to create one or more code snippets in different formats for the digital asset. The method further includes activating an abstraction process to automatically generate a truncated embeddable code snippet after detection of a licensing of the digital asset.

### CROSS-REFERENCE TO RELATED APPLICATION

The present application claims the benefit of and priority to U.S. Provisional Application Ser. No. 63/295,246, entitled “System and Process for Generating Code Snippets to License Digital Content,” filed on Dec. 30, 2021, the entirety of which is hereby incorporated by reference.

### TECHNICAL FIELD

This disclosure relates to a method and system for generating code snippets to license digital content across various verticals and industries.

### BACKGROUND

Digital asset management platforms (e.g., digital licensing platforms) allow published or unpublished digital content to be republished or repurposed through a legal agreement often referred to as a copyright license. While highly vetted digital content licensed by these digital asset management platforms helps attract new audiences and drive brand loyalty (e.g., by enhancing touchpoints between customers and a brand), the digital content licensed by these platforms faces many problems. For example, the digital content licensed by these platforms is generally static and not interactive, and thus a consumer of the digital content may not obtain additional information beyond what is displayed (e.g., static pixels). This prevents a consumer of the licensed digital content from further engagement with the digital content. For example, a consumer viewing a licensed image containing a world famous soccer player playing soccer may be interested in a soccer jersey that the player wears, but the licensed image does not provide additional information (e.g., which brand of the soccer jersey) and/or enablement (e.g., an order link) for the consumer to engage with the licensed image. That is, the digital content licensed by these digital asset management platforms provides a one-way communication process, where consumers cannot engage further with the digital content beyond the displayed static pixels.

In addition, these digital asset management platforms do not provide an effective channel to track the involved entities (e.g., intellectual property (IP) right holder or creator) for a licensed digital asset and thus a proper royalty cannot be timely paid (e.g., paid in real time upon purchase of a licensed content).

Further, these digital asset management platforms do not provide proper analytical tools to identify high-value digital assets when placing digital assets in the market for licensing.

### SUMMARY

To address the aforementioned shortcomings, a method and a system for generating code snippets in licensing digital content is provided. The method includes acquiring a digital asset in a software-as-a-service (SaaS) interface. The method further includes generating metadata and an access uniform resource locator (URL) for the digital asset. The method additionally includes generating a primary JavaScript object notation (JSON) file to create one or more code snippets in different formats for the digital asset. The method further includes activating an abstraction process to automatically generate a truncated embeddable code snippet after detection of a licensing of the digital asset.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 illustrates a block diagram of an example digital asset management platform, according to some embodiments.

FIG. 2 illustrates an exemplary online content registration form, according to some embodiments.

FIG. 3 illustrates a flow diagram of an example digital asset licensing process, according to some embodiments.

FIG. 4 illustrates a flow chart of an example method for generating an embeddable URL or code snippet, according to some embodiments.

FIG. 5 illustrates example code snippets before and after an abstraction process, according to some embodiments.

FIGS. 6A-6E collaboratively illustrate an example interactive digital asset, according to some embodiments.

FIG. 7 illustrates an example computing device for implementing one or more disclosed methods, according to some embodiments.

### DETAILED DESCRIPTION

In the following detailed description of embodiments, reference is made to the accompanying drawings which form a part hereof, and which are shown by way of illustrations. It is to be understood that features of various described embodiments may be combined, other embodiments may be utilized, and structural changes may be made without departing from the spirit and scope of the present disclosure. It is also to be understood that features of the various embodiments and examples herein can be combined, exchanged, or removed without departing from the spirit and scope of the present disclosure. In addition, reference numerals and descriptions of redundant elements between figures may be omitted for clarity.

According to an embodiment, the methods and functions described herein, such as automatically generating code snippets to license digital content (also referred to as digital asset(s)), may be implemented as one or more software programs running on a computer processor (e.g., a control unit or controller). According to an embodiment, the methods and functions described herein may be implemented as one or more software programs or firmware programs running on a standalone computing device or embedded apparatus, such as a tablet computer, smartphone, personal computer, server, or any other computing device, or on an appliance or apparatus with a controlling program. Dedicated hardware embodiments including, but not limited to, application-specific integrated circuits, programmable logic arrays, and other hardware devices can likewise be constructed to implement the methods and functions described herein. Further, the methods described herein may be implemented as a device, such as a non-transitory computer-readable storage medium or memory device, including instructions that when executed cause a processor to perform the methods and functions described herein.

According to some embodiments, the disclosure provides a digital asset management platform that employs a software-as-a-service (SaaS) interface for receiving or creating a digital asset and uses code snippet generation technology to make a digital asset more interactive. For example, the digital asset management platform disclosed herein uses certain code snippets to first manipulate a digital asset to make it more interactive before placing it in the market for licensing. These code snippets may make a digital asset more dynamic, more commerce-based, and thus more interactive and attractive to consumers or businesses than digital assets licensed through other existing digital asset licensing platforms. In addition, the disclosed SaaS interface may include application extensions such as non fungible tokens (NFT), augmented reality (AR), virtual reality (VR), and metaverse, all of which promote the applications and thus licensing of the digital assets. Further, the disclosed digital asset management platform also includes a blockchain that acts as the digital asset licensee and IP ledger as well as the financial technology (fintech) backbone for royalty payment disbursements via various crypto wallets that are inherent with each user. Further, an embeddable code snippet (or URL) is created and used in licensing instead of static pixelated art. This makes the licensed digital asset more informative, controllable and manageable even after licensing.

According to some embodiments, the disclosed digital asset management platform has certain benefits or advantages over other existing digital asset management platforms. For example, by deploying code snippets online for visual communication purposes to make the digital asset more interactive, it is transformative for businesses and consumers since interactive objects included in a digital asset may get more attention or touchpoints due to the introduced interactivity, and consumers can engage more with one or more objects included in the transformed digital asset. In addition, by applying certain tracking and analytical tools, the digital assets including the added touchpoints provided by the introduced interactivity of the digital asset are measurable from the image outside frame to the inside interactive objects, which then allows for certain metrics to be generated, which can be further utilized to determine monetary affiliate incentives and affordable licensing prices to improve licensing of the digital assets. Further, the digital asset management platform disclosed herein uses a ledger in blockchain to capture entities contributing to the digital assets, which then facilitates royalty payments to the proper entities. In addition, by using dynamic code snippets in licensing, the whole licensing journey is more informative, controllable and manageable.

It is to be understood that the features, benefits, and advantages described herein are not all-inclusive, and many additional features and advantages will be apparent to one of ordinary skill in the art in view of the figures and the following descriptions.

Overall System

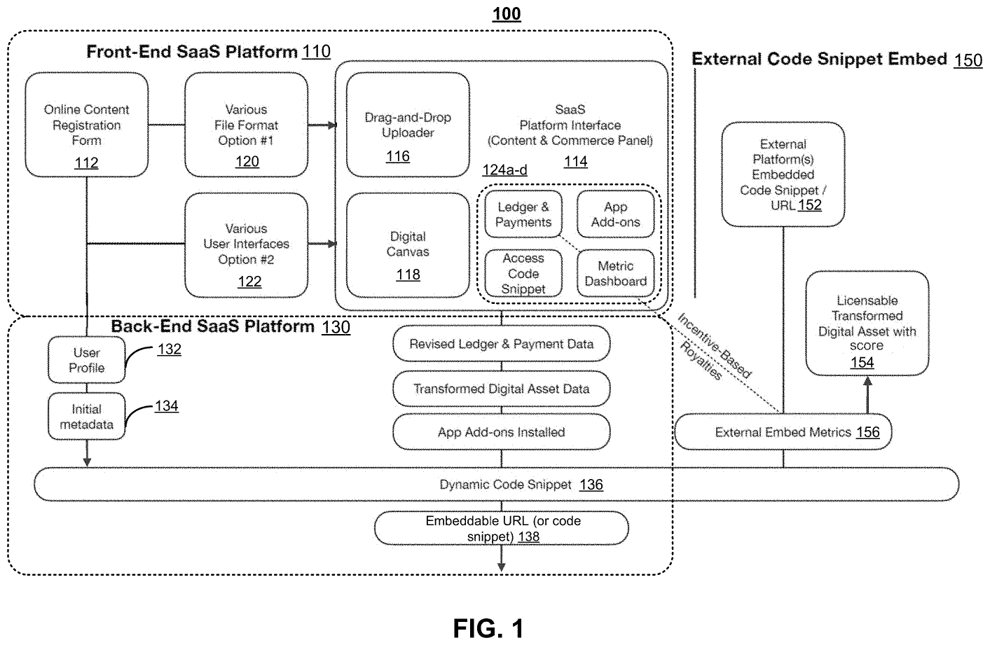

FIG. 1 illustrates a block diagram of an example digital asset management platform 100, according to some embodiments. As illustrated, the example digital asset management platform 100 may include a front-end SaaS platform 110, a back-end SaaS platform 130, and an external code snippet embedding platform(s) 150 coupled to the front-end SaaS platform 110 and the back-end SaaS platform 130.

The SaaS front-end platform 110 may include an online content registration form 112 for initiating a digital asset and a SaaS platform interface 114 for receiving, creating, and/or further manipulating a digital asset. The online content registration form 112 may allow necessary information for a digital asset to be provided or acquired when submitting a digital asset to the digital asset management platform 100. The acquired information may vary and depend on the type of a digital asset. Here, a digital asset is digital media or digital content that can be stored digitally and is uniquely identifiable that organizations can use to realize value. Examples of digital assets may include but are not limited to, files, documents, images, audio, videos, logos, slide presentations, spreadsheets, websites, and so on. In some embodiments, the digital assets may also include certain holograms, which are low-powered laser-enabled expression of digital content like interactive tablet glass screens that allow for expression and interaction with digital content. In some embodiments, the digital assets may also include certain visible and invisible watermarks (e.g., QR codes or pixel mapping/manipulation), which may be applied to multi-device application scenarios (e.g., mobile device as a second screen for content engagement and commerce). In some embodiments, the digital assets may include additional formats of content or assets not described above but that can promote engagement and/or commerce.

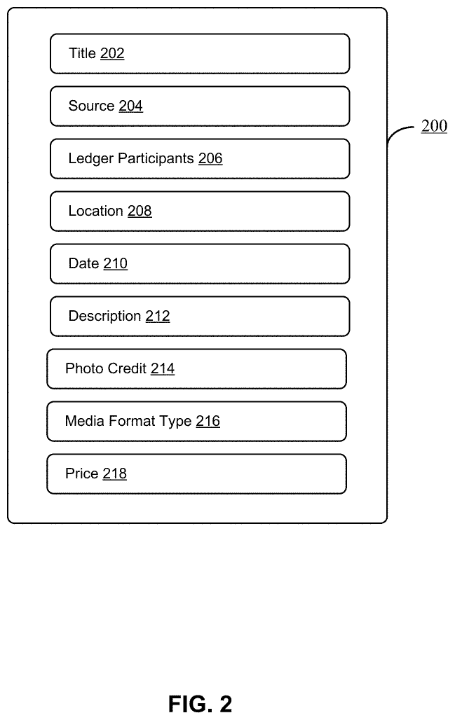

FIG. 2 illustrates an example online content registration form 200 for a digital asset (e.g., an image taken at an event), according to some embodiments. As illustrated, the online content registration form 200 may include a set of user input windows for collecting different information related to the digital asset submitted to the digital asset management platform 100. In one example, the information input by a user may include but is not limited to a title 202, source 204, ledger participants 206, location 208, date 20, description 212, photo credit 214, media file format 216, price 218, etc.

The title 202 may be a title given by an organizer of an event or may be a title that the image owner provides according to his/her preference. In one example, a title for an event may be “Esports Championship Series Season 8,” which means that the digital asset is taken from the event of “Esports Championship Series Season 8.” Source 204 may indicate the source of the digital asset, e.g., which entity provides the digital asset. In one example, the source 204 may be the intellectual property (IP) owner. The ledger participants 206 may include distributed ledgers that are held, reorganized, and controlled by individuals called nodes in a blockchain environment. The location information 208 may indicate where the event associated with the digital asset was held. The date 210 may indicate when the event was held or when the digital asset was created or produced (e.g., when an image is taken). In some embodiments, the date 210 may also indicate when the interactivity for an interactive digital asset expires (e.g., when an interactive image falls back to a static image). Accordingly, in some embodiments, the date 210 may include one or more dates, each corresponding to different aspects of a digital asset. The description 212 may include additional, more detailed information for the digital asset. For example, for the event titled “Esports Championship Series Season 8,” the description part may include “Esports Championship Series (ECS) Season 8 is the latest iteration of the world's most watched CS:GO tournament,” or other similar descriptions that provide additional information to better understand the digital asset or event, especially for others that are not familiar with the event. The photo credit 214 (also referred to as image credit, art credit, or others depending on the type of digital asset referred thereto) may tag someone that contributes to the digital asset, such as a photographer that has taken an image. The media file format 216 may indicate the specific format of the digital asset, which can be a photo, video, highlights, in-game content, and so on as further described in detail below. The price information 218 may indicate the price for purchasing the digital asset license. Depending on the buyer who purchases the digital asset, the price may include multiple price options, e.g., a first price for a member and a second price for a non-member, a third price for a first type of license, and a fourth price for a second type of license. It is to be noted that the registration form shown FIG. 2 is for illustrative purposes, the registration form may include additional or fewer items or other different items than those shown in the figure.

Refer back to FIG. 1: As illustrated in the figure, when submitting a digital asset to the SaaS platform interface 114, there are various file format options 120 to choose from and various user interface options 122 to choose from. The file format option 120 may indicate the types of media files that can be uploaded to platform 100. In some embodiments, the media file formats may include photos, videos, highlights, in-game or virtual content, generative artificial intelligence (AI) artwork and the like. The photos and videos may be the photos or videos taken from an event. The highlights may be clips of video footage (e.g., game footage) that highlight some key moments in an event. The in-game content may include a game's audio-visual content, including the visual appearances of its characters, and corresponding in-game data that is rendered and made available to users or viewers of the game content. This may include audio-video content created for VR or AR applications. In some embodiments, the media file formats may include other types of media files not mentioned above.

The user interface option 122 may indicate various artboards that can be optionally added to the digital canvas 118, to allow to compare different design iterations, test color schemes, or ensure the created digital assets to be consistent with one another. An artboard may be an individual workspace in a Photoshop or Illustrator file. It can be thought of as a virtual piece of paper on a larger canvas (e.g., the digital canvas 118).

In some embodiments, the uploader interface may be a front-end interface supported by certain back-end applications included in the platform 100. These back-end applications may add additional information to the uploaded digital asset. Some example back-end applications may include but are not limited to metadata generation, profile collection, blockchain integration, and image recognition applications, among others.

The metadata generation application may allow initial metadata 134 to be automatically generated for an uploaded digital asset. For example, once a file is uploaded through the file upload interface, the digital asset management platform ingests the uploaded file and then tags the file with the metadata. Metadata includes information that describes the digital asset which enables platform users to search and find the digital asset in the platform. In some embodiments, the digital asset management platform 100 uses artificial intelligence to attach relevant metadata tags to an uploaded digital asset based on what the platform “sees” from the uploaded digital asset. In some embodiments, the digital asset management platform 100 may also allow users or employ machine learning to edit, add, or delete tags to improve search results. In some embodiments, certain security features may also be a part of the metadata that may be used to control which user(s) or user group(s) can access an uploaded digital asset and how they can use it. User(s) or user group(s) can then download or access approved digital assets for their use or share them with collaborators and partners via portals, share links, embed codes, and system integrations.

As also illustrated in FIG. 1, in some embodiments, user profile 132 may be also generated in the back-end SaaS platform 130. The user profile 132 includes information for the user submitting the online content registration form as well as the digital asset associated with the online content registration form. In some embodiments, the user profile 132 instead records information related to subscribers (e.g., potential licensees). The user profile 132 at this point may include information such as SaaS user unique identifier (UID), IP or usage rights, position of the ledger and payment, and so on, all of which may be generated upon a subscriber creates an account. In some embodiments, the user profile additionally includes records of in-platform behaviors (e.g., hover, click) once a licensed digital asset is deployed.

Continuously refer to FIG. 1: Once a digital asset is submitted to the platform 100, the digital asset may be received in the SaaS platform interface 114. In some embodiments, the SaaS platform interface 114 may be also referred to as the content & commerce panel for its focus on the digital content and commerce content in the present disclosure. For example, the SaaS platform interface 114 may allow users to place nodes on various elements of a digital asset to make the digital asset interactive (e.g., respond to user clicks or hovering over). This includes but is not limited to inputting thumbnails, product descriptions, call-to-actions (CTAs) using a certain form-based graphical user interface (e.g. GUIs) or the like.

According to one embodiment, a digital asset managed by the digital asset management platform 100 may be an existing digital asset received through a drag-and-drop uploader 116 included in the SaaS platform interface 114 or may be instantly created through a digital canvas 118 included in the SaaS platform interface 114. The drag-and-drop uploader 116 may be accessed through a subdomain URL which is a drag-and-drop interface, which allows a user to choose a file (e.g., drag a file or browse for a file) from his/her own computer's hard drive(s) or cloud storage account. In this way, a digital asset may be uploaded directly via a memory/SIM card. In some embodiments, instead of uploading a digital asset from a local memory/SIM card, the SaaS platform interface 114 may also receive a digital asset through a third party file transfer, which may be initiated via a third party API call (e.g., Flickr®, SmugMug®, or other data asset management platforms).

In some embodiments, instead of receiving an already existing digital asset, the SaaS platform interface 114 may allow a user to instantly create a digital asset using the digital canvas 118 included in the SaaS platform interface 114. According to some embodiments, the SaaS platform interface 114 may include certain graphic design tools, such as selection, color palette, crop, type, and clipping path tools, which allow a user to create a digital asset. For example, an artisan may use the digital canvas 118 to create a digital asset such as an avatar, which can be also managed (e.g., licensed) by the disclosed digital asset management platform 100. In some embodiments, a digital asset may be created using other different means. For example, an image may be created using a text-to-image model, which may be a deep learning-driven model (e.g., Stable Diffusion) that can be configured to generate detailed images conditioned on text descriptions. In some embodiments, a such text-to-image model may be also applied to other different tasks such as inpainting, outpainting, and generating image-to-image translations guided by a text prompt. In some embodiments, in addition to generating unique images, the text-to-image model, when properly configured, may also serve as a gateway towards automating an object-based clipping path. In some embodiments, generative AI may be also used to generate digital assets, even without text input.

In some embodiments, in addition to the fundamental graphic design toolbox, the SaaS platform interface 114 may include an additional set of tools or components 124a-d for manipulating, licensing, and/or monitoring digital assets included in the SaaS platform interface 114. In the illustrated embodiment in FIG. 1, the set of tools or components may include a ledger & payment tool 124a, app add-ons 124b, access code snippet 124c, and metric dashboard 124d.

The ledger & payment tool 124a may use blockchain technology to track a digital asset received or created in the SaaS platform interface 114. This includes using a ledger to track the license purchase of a digital asset and/or track when the licensed digital asset is placed in various spaces (e.g., publications, blogs, metaverses, virtual worlds, etc.).

In some embodiments, the ledger & payment tool 124a may rely on AI and image recognition technology to track the placement of a digital asset within content commerce, VR, AR, metaverse, NFT offerings, and the like. In one example, Amazon Rekognition® automating image and video analysis tool may be used to track the placement of a digital asset included in the platform 100. In some embodiments, UIDs that are dynamically generated in the licensing process may be used instead to track the licensed digital asset/code snippet (even if a same visual digital asset is placed by two or more different account holders that have different UIDs).

In some embodiments, the ledger & payment tool 124a may also capture the author, primary IP holder, associated IP holders and contributors, price history, revision history, revenue, and royalty distributions for a digital asset. Here, revision history may refer to the active lifecycle of a code snippet. Since a code snippet is dynamic (e.g., interacting with other APIs, for example, an NFL broadcast dataset per game quarter), each object that changes within the dynamic code-base/snippet may be viewed as “revision history.” In some embodiments, royalty stakeholders (e.g., primary and secondary IP holders, contributors, photographers, videographers, animators, and/or 3D artists) may be aligned with each individual digital asset and inherit all data including licensing history and user behavior data associated with each digital asset.

In some embodiments, the ledger & payment tool 124a may also apply blockchain as the financial technology (fintech) backbone for royalty payment disbursements via various crypto wallets, traditional fiat currency, or other forms of currency that are inherent with each IP owner.

In some embodiments, by introducing the blockchain environment, the disclosed digital asset management platform 100 may be also considered an online distribution platform where some smart contracts reside. Here, smart contracts may refer to executable software or code that enables nodes in the blockchain network to interact with the data stored on the blockchain and acts automatically if some conditions are met. By including the smart contract(s) in the blockchain environment, it may automate and standardize a multitude of digital asset licensing-related transactions, such as those authorizing the use and exploitation of the license-protected content and remuneration. In some embodiments, smart contracts may help the distribution of revenues. For example, if a licensed digital asset generates a certain amount of remuneration, a smart contract may distribute the revenue amongst right holders according to certain standards.

It should be noted that, while blockchain is described as the digital asset license and IP ledger and the financial technology backbone, the disclosed digital asset management platform is not limited to such configuration. In some embodiments, the disclosed digital asset management platform may instead include a transparent data visualization dashboard that acts as the digital asset licensee and IP ledger as well as the financial technology (fintech) backbone for royalty payment disbursements via various currency wallets that are inherent with each user.

The app add-ons 124b may allow certain applications to be added to the SaaS platform interface 114. This may include applications that facilitate the creation, manipulation, licensing, and/or application of digital assets. Some example applications may include but are not limited to color hover animations, creative graphic outline options, and certain feature manipulations to allow a digital asset to integrate with external platforms. Other example applications may include but are not limited to NFT, AR/VR, enhancing content engagement commerce conversion, blockchain, metaverse, and experiential interactive easter eggs.

An NFT is a unique digital identifier that cannot be copied, or substituted, and that is recorded in a blockchain. In digital asset management, an NFT typically includes reference to a digital asset received or created in the SaaS platform interface 114, such as interactive artwork, and branded 3D or 4D objects to invite individuals to buy. The ownership of an NFT is also recorded in the blockchain and may be transferred by the owner, allowing the NFT to be sold and traded. For example, an NFT may confer licensing rights to use a digital asset created in the SaaS platform interface 114 for a specified purpose, and the creator of the digital asset may attach the royalty to the NFT.

In some embodiments, a digital asset may be also licensed to users in specific AR, VR, and metaverse applications. For example, for AR/VR applications, the digital asset management platform 100 may allow AR/VR consumers or users to purchase a license of a digital asset so that the consumers can interact and/or buy simulated physical goods or virtual goods included in the digital asset, and/or participate in sponsored experiences. Similarly, a metaverse consumer or user may also purchase a license of a digital asset for application in the metaverse. In some embodiments, a digital asset may include interactive objects (e.g., 3D couches, beds, artwork, and/or pre-developed rooms) for purchase that will reside within a user's metaverse virtual real estate. In one example, an object in a digital asset may be templated with a crypto, commerce enabled opportunity for a user/avatar to opt into with the purchase of a branded swatch. Similar to gaming skins, the purchase of the branded swatch may unlock an exclusive experience for the object owner within a duration of time, e.g., during a live virtual or physical event.

In some embodiments, one or more easter egg applications may be also included in the digital asset management platform 100 to improve user experience in gaming or other participated activities. An easter egg application may be a digital collectible message, image, or feature hidden in software, a video game, a film, or another, usually electronic, medium hidden within a digital asset for users to search for and attempt to attain and that can potentially unlock a live/virtual experience.

In some embodiments, the SaaS platform interface 114 may further include an application for social card generation and further embedding through embeddable URLs. An embedded social card or image is a visual element that is added to a webpage or other digital content. It is typically linked to a social media account or other online sources, and it displays information such as the title, description, and image associated with the linked content. To embed a social card or image, a special code or widget provided by the platform hosting the content may be obtained. For example, to embed a tweet from Twitter®, the “Embed Tweet” tool may be used to generate a code that can be copied and pasted into a webpage or blog. Embedding social cards or images can be a useful way to share content from other platforms on a person's own website or blog, and it can also help to drive traffic and engagement back to the original source.

In some embodiments, the SaaS platform interface 114 may also include certain web browser applications and/or extensions to manipulate the browser. At this moment, the browser stakeholder and third-party developer may reside on the ledger. Part of this manipulation may align with the “one click buy” of an interactive commerce object in the web browser. The wallet may be aligned with their preferred online payment method. In some embodiments, a similar approach may be also configured for mobile applications, which may align with “one click buy” when SMS social card is manipulated.

In some embodiments, the SaaS platform interface 114 may include additional app extensions not described above.

The access code snippet 124c may be a URL for accessing the digital asset online (e.g., content delivery network (CDN)). In some embodiments, an access code snippet may include certain other code snippets included in a digital asset. For example, a digital asset may include one or more URLs that allow access to other websites or information resources.

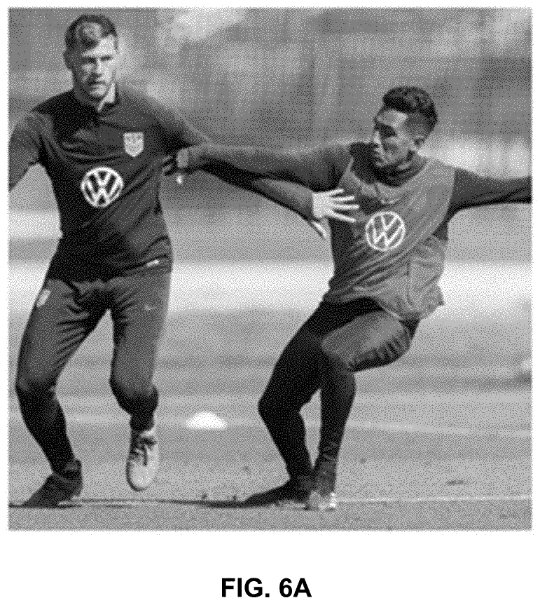

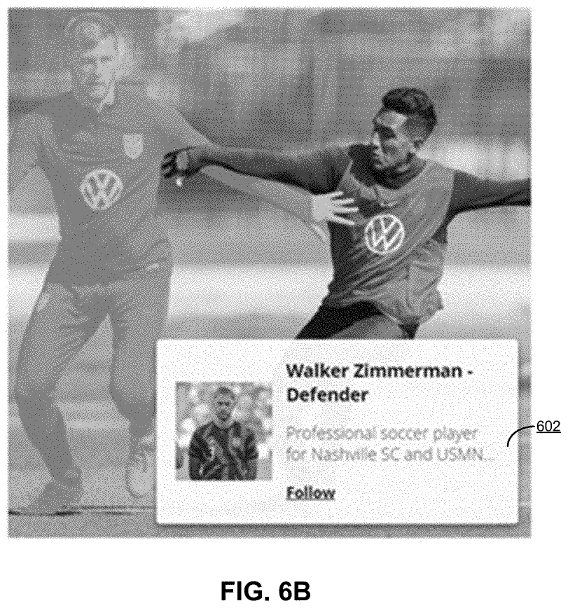

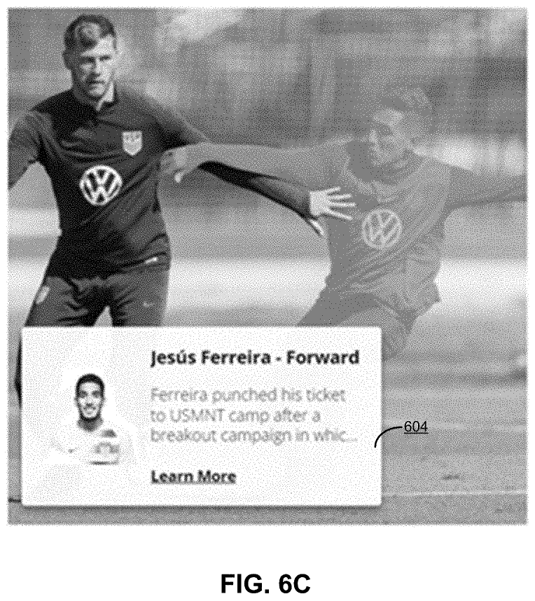

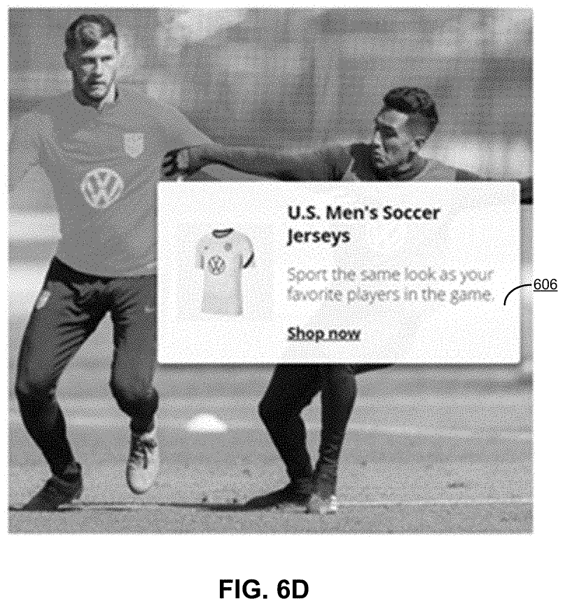

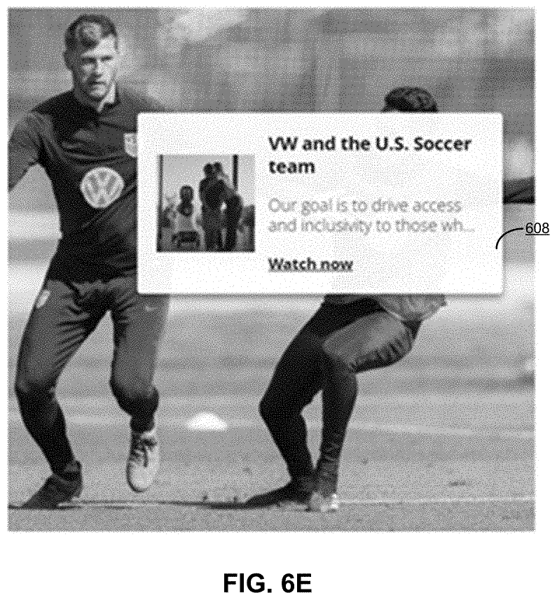

The metric dashboard 124d may compile and organize external user (e.g., viewer) behavior within a digital asset after the deployment of a licensed digital asset. The external viewer behavior may include but is not limited to hover or click, as will be described in more detail in FIGS. 6A-6E. In some embodiments, by compiling and/or organizing the external user behavior, the metric dashboard 124d may further generate an engagement score and/or a commerce score for a digital asset. The engagement score may reflect the popularity of a digital asset (e.g., how many times external users hover over elements included in a digital asset). In some embodiment, based on the commerce activities (e.g., click to purchase an object(s) included in a digital asset), a commerce score may be further generated for a digital asset. It is to be noted that not every digital asset has a commerce score, since some digital assets may not have commerce content (e.g., objects for purchase). In some embodiments, an additional overall score (e.g., an overall score generated for the platform 100) may be further generated for a digital asset based on its engagement score and/or commerce score. In some embodiments, the engagement score, commerce score, and/or overall score may allow users to identify high-value digital assets. In some embodiments, the metric dashboard 124d may be coupled to the ledger & payment tool 124a and/or the external embed metrics 156 to obtain necessary information in calculating different scores.

In some embodiments, although not shown in FIG. 1, the SaaS platform interface 114 may enable additional interactivity features or certain other features or functions to be added to a digital asset. These features or functions may include but are not limited to, custom hotspot icon links, auto-populated ad placement, and currency and distribution dropdown menus (not shown). The custom hotspot icon links may allow a user to add a customized hotspot icon to a digital asset. Hotspots (which may be identified based on AI or image recognition techniques) are points or areas, in a picture, that pop up a window when clicked or hovered over. The popup may include text, links, and the like, and can be made really interactive with sound, images, videos, a website, or a combination of all of these. The auto-populated ad placement may allow options for ad placement within a digital asset, including an option for setting an auto-populated field within the digital asset. By introducing the additional interactivity to a digital asset, a licensed digital asset may increase engagement, and commerce and democratize economic opportunities. The increased interactivity for a digital asset is further described in detail in FIGS. 6A-6E.

The currency and distribution dropdown menus may include a set of dropdown menus for selecting a distribution channel and the corresponding pricing information for a digital asset. In some embodiments, the dropdown menus may include a set of predefined values. In some embodiments, the currency and distribution each have a corresponding dropdown menu, allowing a value to be independently selected for a digital asset.

It is to be noted that the above described elements of the SaaS platform interface 114 are merely for exemplary purposes, but not for limitations. In some embodiments, the disclosed SaaS platform interface 114 may include fewer or additional elements. In one example, a navigation bar may be additionally included in a digital asset. In another example, XML (eXtensible Markup Language) may be also included to assist with storing, transmitting, and reconstructing arbitrary data. XML is a markup language that is used to encode structured data in a text file. XML uses a set of tags to describe the data and its relationships, making it easy to read and understand by both humans and machines. XML is often used to store and transmit data over the internet, as it can be easily processed by a wide range of software applications

Referring now to the back-end-end SaaS platform 130: As illustrated in FIG. 1, after an online registration form is received, a user profile 132 and initial metadata 134 may be generated, as described earlier. The user profile 132 may include information for a user submitting the online content registration form. The initial metadata 134 may include information for the digital asset submitted to the SaaS platform interface 114. In some embodiments, the back-end-end SaaS platform 130 may include a metadata generation module (not shown) configured to automatically generate metadata for the submitted digital asset. The metadata generation module may identify file format, image size, resolution, camera make and model, lens model, orientation, exposure time, f-number, exposure program, color specification, and product SKU via filename in all formats of rich text. In some embodiments, the metadata generation module may also identify event title, location, IP holder, photo credit, license deal terms and revenue splits, etc. In some embodiments, the metadata generation module may rely on the submitted online content registration form to identify this information, or automatically retrieve certain information from the digital asset. For example, an image may generally include time, date, location, resolution, camera make and model, and so on, which can be easily retrieved from the image file. In some embodiments, machine learning based approaches may be used to automatically generate the initial metadata 134.

Continuously refer to the back-end SaaS platform 130: Upon submission or creation of a digital asset, the back-end SaaS platform 130 may generate a dynamic code snippet 136 and an embeddable URL (or code snippet) 138 that can be embedded into an external code snippet embedding platform 150 (e.g., a blog and the like). The embeddable URL or code snippet may be generated for embedding into an external code snippet embedding platform 150 upon purchase of a digital asset license.

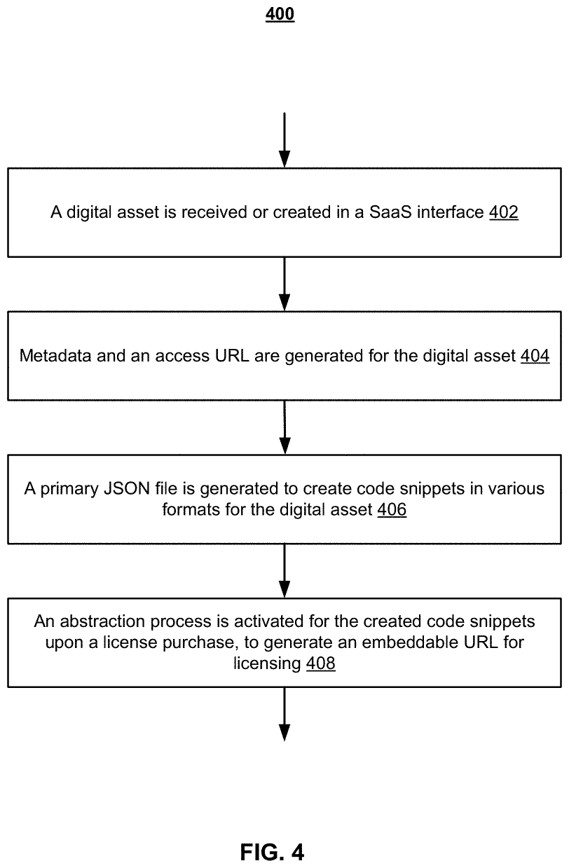

In some embodiments, the dynamic code snippet 136 may be a code snippet that may be dynamically controlled based on certain circumstances. For example, through a proper code “snippet,” the access to a digital asset may be dynamically controlled based on the IP location, profile attributes, or segmented sponsor media buys. For another example, if a purchased license expires, a licensed digital asset may be voided by rendering that specific code snippet useless. In some embodiments, an embeddable URL (or code snippet) 138 may be further generated upon the purchase of a license for a digital asset. In some embodiments, the back-end SaaS platform 130 may include an URL/code snippet generation module (not shown) configured for the generation of an embeddable URL (or code snippet) 138. The specific process for generating an embeddable URL or code snippet is further described in detail in FIG. 4.

In some embodiments, through the process of generating an embeddable URL (or code snippet) 138, certain additional information may be modified for the associated digital asset. For example, as illustrated in FIG. 1, the ledger and payment data may be revised to reflect the license purchase as well as loyalty payment, among other possible changes. In addition, the digital asset may be transformed from pixelated static imagery into interactive, commerce enabled data by using certain code snippets. For example, certain code snippets may be generated to allow objects included in a digital asset to be interactive or enable commerce experience, as further described in FIGS. 6A-6E. This then drives value for editorial licenses, IP holders, sponsors, and/or creators (e.g. photographers, videographers, editors, and 3D/4D artists). In some embodiments, certain app add-ons may be installed to enable the placement of a licensed digital asset. For example, certain VR/AR applications may be installed if a license is purchased for a digital asset generated for VR/AR applications.

In some embodiments, once the embeddable URL (or code snippet) 138 is generated, the URL or code snippet may be embedded into an external code snippet embedding platform 150, which renders the digital asset to be displayed therein.

Refer now to the external code snippet embedding platform 150: According to some embodiments, the embeddable URL (or code snippet) 138 may be embedded into the external platform to have an external platform embedded code snippet/URL 152. Through the embedding process, the dynamic code snippet 136 may be embedded into the external code snippet embedding platform 150, which then renders the transformed digital asset 154 to be displayed and/or functional for certain actions or activities (e.g., in AR/VR or metaverse). In some embodiments, an external embed metrics 156 may be also included in the external code snippet embedding platform 150, which then provides necessary information for generating metrics for a digital asset, including the aforementioned engagement score or commerce score. In some embodiments, a digital asset may be licensed to multiple different external code snippet embedding platforms. At this moment, each external code snippet embedding platform 150 may provide metric information back to the SaaS platform interface for generating the engagement score and/or commerce score. In some embodiments, a separate score(s) may be also generated for a digital asset rendered in each external code snippet embedding platform, as indicated by the licensable transformed digit asset with score 154 shown in FIG. 1.

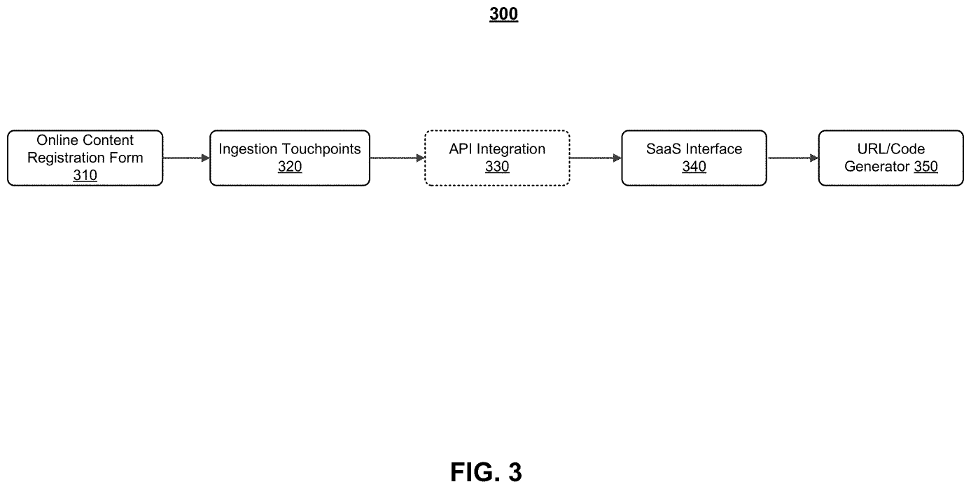

It is to be noted that the above described elements for the digital asset management platform 100 are merely for exemplary purposes, but not for limitations. In some embodiments, the disclosed digital asset management platform 100 may include additional or fewer components than those illustrated in FIG. 1. A specific process for licensing a digital asset is further illustrated in FIG. 3.

FIG. 3 illustrates an example flow diagram 300 for a content licensing process, according to some embodiments. As illustrated, the content licensing process 300 may start with an online content registration form 310 for submitting a digital asset to the disclosed digital asset management platform 100. The digital asset may be submitted through different ingestion touchpoints 320, which may include, but are not limited to, uploading from a memory or SIM card, uploading via a URL, or transferring through a cloud third-party service (e.g., Flickr, SmugMug, etc.). The digital asset may be submitted to a SaaS interface 340. In some embodiments, there are certain API integration(s) 330 that accompany the submission process. For example, metadata may be generated by a metadata generator for a submitted digital asset, a royalty ledger may track the submitting process and identify the loyalty stakeholder that is aligned with the digital asset. In addition, certain image recognition techniques may be integrated for identifying content included in the digital asset.

In the SaaS interface 340, certain preparations may be performed for licensing the digital asset. For example, certain filing naming, resolution adjustment, and file format adjustment may be performed, to make sure the digital asset is aligned with the format, resolution, and name requirements of the licensee. In addition, content or commerce content may be recognized by image recognition techniques. Further, the digital asset may be stylized, filtered, and/or animated. The pricing information may be also built for the digital asset before being placed for licensing. In some embodiments, certain app extensions may be integrated into the SaaS interface 340. These app extensions may include NFT, AR/VR, content commerce, blockchain, metaverse, easter egg, and the like as described earlier. The prepared digital asset can be then placed in the market for licensing.

In some embodiments, an URL/code generator 350 may further generate a URL or 1-2 lines of copy snippet upon license purchase of the digital asset by a licensee. The generated URL or code snippet may be an embeddable URL or code snippet that can be embedded into an external code snippet embedding platform. A transformed digital asset corresponding to the generated URL or code snippet may be displayed after the embeddable URL or code snippet is embedded in the external code snippet embedding platform. In one example, the generated code snippet may inherit the information or features including the image URL via CDN, a unique licensee ID to enable anti-privacy, the source of the digital asset (i.e., the ingestion touchpoint), metadata of the digital asset, royalty ledger information of the digital asset, activated SaaS apps for the digital asset, licensing information (e.g., price), where it was used or published. All of this information is attached to the digital asset and is retrievable in the SaaS interface 340 via the generated URL or 1-2 lines of code snippet. A specific process for generating an embeddable code snippet is further described in detail in FIG. 4.

### Embeddable Code Snippet Generation

FIG. 4 illustrates a flow chart of an example method 400 for generating an embeddable URL or code snippet, according to some embodiments. The method 400 may be implemented by a URL/code generator, and may be generated during a content licensing process.

At step 402, a digital asset is received or created in the SaaS platform interface 114. As described, the digital asset may be an existing digital asset received through different ingestion touchpoints. Alternatively, the digital asset may be instantly created by a user in the digital canvas 118 included in the SaaS interface.

At step 404, after submission of the digital asset via the SaaS platform interface 114, data is populated within a database, and a unique URL is generated for that specific digital asset. The data may include metadata generated for the digital asset, and the unique URL may be generated for accessing the digital asset (e.g., via CDN). The metadata may be generated by a metadata generator, according to some embodiments.

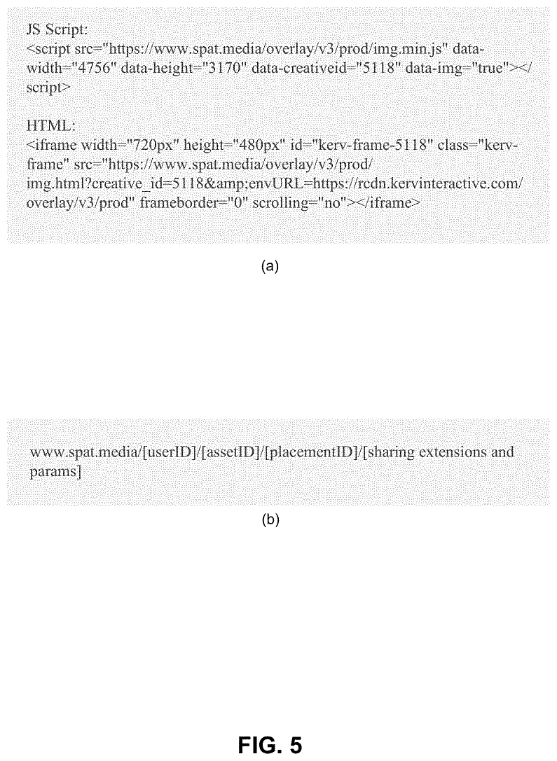

At step 406, a primary JavaScript objection notation (JSON) file is generated to capture the data and use the data to create code snippets in various formats (e.g., hypertext markup language (HTML) and JavaScript, as shown in part (a) in FIG. 5. The created code snippets in various formats may be aggregated based on the user SaaS selection of various behavior and extensions during a purchase of the licensed digital asset. The aggregation process may generate pre-truncated, pre-abstracted code snippets interpolated from strings of code representing different layers of features of the digital asset.

At step 408, an abstraction process is activated upon an individual licensee's purchase of the digital asset to generate a licensable code snippet. Through the abstraction, only the relevant data is revealed in this “snippet,” along with unique identification (UID) strings, anti-piracy tracking tokens and webhooks, and time stamps corresponding to each licensee. That is, the abstraction process filters the pre-truncated, pre-abstracted code to generate a lean code snippet by transforming several identifiable lines of code into a lean, fewer unidentifiable lines of code (e.g., 1-2 lines of code or single URL), as shown in part (b) in FIG. 5.

It is to be noted that the generated URL may be a dynamic URL since the associated digital asset may be stored in a database and pulled for display on pages on demand by the licensees. By using dynamic URL, it may allow different URLs to have the same content so that different licensees (or different user accounts as described earlier) may link to URLs with different parameters which have the same digital content.

It is also to be noted that the generated URL or code snippet at step 408 is different from the URL (via CDN) generated earlier at step 404. The URL generated at step 404 is an access URL directed to a digital asset (which may be a static pixelated image), while the URL or code snippet generated after the abstraction process at step 408 is directed to the pre-truncated, pre-abstracted code snippet for rendering the digital asset in the transformed form.

In some embodiments, the generated embeddable URL or code snippet may be embedded into the external code snippet embedding platform associated with the licensee, as described earlier. The embedding of the embeddable URL or code snippet in the platform (e.g., a social network platform, blog and/or publication) associated with the licensee may render the digital asset to be displayed in a format or style as expected.

### Interactive Digital Asset

FIG. 6A illustrates an example of an interactive digital asset, according to some embodiments. The digital asset is an image showing two soccer players in a certain event. Instead of being a static image, the image shown in FIG. 6A is an interactive image that allows users to interact with the image. For example, if a mouse hovers over the left player's head, the player can be highlighted (e.g., with a different color) and the profile information for the left player may pop up in a window, as shown in FIG. 6B. As can be seen from the text in the pop-up window 602 in FIG. 6B, the player is a soccer player named Walker Zimmerman, who is a professional soccer player for Nashville SC and USMNT (U.S. Men's National Team). In addition, there is a “Follow” link in the pop-up window 602, which allows a fan to follow the player on a social network. Similarly, if a mouse hovers over the right player's head, the profile information for the right player may pop up in window 604, as shown in FIG. 6C. As shown in the text in the pop-up window 604, the player is a soccer player named Jesus Ferreira, who is a professional soccer player that has punched his ticket to USMNT camp after a breakout campaign. In addition, there is a “Learn More” link in the pop-up window, which allows a fan to read more about the player from a linked website (https://www.ussoccer.com/players/f/jesus-ferreira).

As further illustrated in FIG. 6D, when a mouse hovers over the shoulder of the left player, another window 606 pops up, which shows information about the jersey that the player wears. As illustrated, the jersey is a “U.S. Men's Soccer Jersey.” In addition, certain commerce language such as “Sport the same look as your favorite players in the game” is also included in the pop-up window 606. Also included in the pop-up window 606 is a “Shop now” link (https://www.nike.com/t/us-mens-pre-match-short-sleeve-soccer-top-3CONqz/CZ4327-102), which, upon a click, directs a person to a website for purchasing the same jersey as the player wears. FIG. 6E further illustrates a scenario when a mouse hovers over the logo of the jersey worn by the left player. As can be seen from a pop-up window 608 in FIG. 6E, the logo is for VW (Volkswagen) that sponsors the U.S. Men's National Team. In the pop-up window 608, there is also a “Watch Now” link (https://www.youtube.com/watch?v=MtClzPxie-0) that directs a person to a video having the topic “VW and the U.S. Soccer team share one goal.” From FIGS. 6A-6E, it can be seen that the image is interactive, but not a static image as other licensed images. The displayed active image may be generated based on the code snippet generation technology described above and may be more transformative for businesses and consumers in visual communications when compared to other licensed static images.

It is to be noted that while the above described different parts are highlighted when a mouse hovers over or clicks each part, in some embodiments, the interactive image may sequentially highlight different parts of the image to indicate which part(s) in the image is interactive.

It is also to be noted that the above image is for illustrative purposes. In different images, there may be different parts or objects that can be highlighted and interactive. In addition, the described interactivity is not limited to the sports or gaming industry but can be applied to digital assets in different business fields. For example, for an image in real estate, different pieces of furniture and appliances in an image may be rendered interactive, and for an image in the beauty industry, lipstick and eyeshadow in an image may be rendered interactive.

It is also to be noted that, in some embodiments, when making a pixelated digital asset interactive, an additional object (which is not part of the original digital asset) may be further generated. For example, an illustrative bubble may be created that bounces in position or off the 4 “walls” of an image frame.

### Computing Device

The methods described above, including the methods of generating code snippets in content licensing, are, in some embodiments, performed on a computing device. Examples of a computing device can include a personal computer, desktop computer laptop, server computer, a computing node within a cluster, message processors, hand-held devices, multi-processor systems, microprocessor-based or programmable consumer electronics, network PCs, minicomputers, mainframe computers, mobile telephones, PDAs, tablets, pagers, routers, switches, and the like.

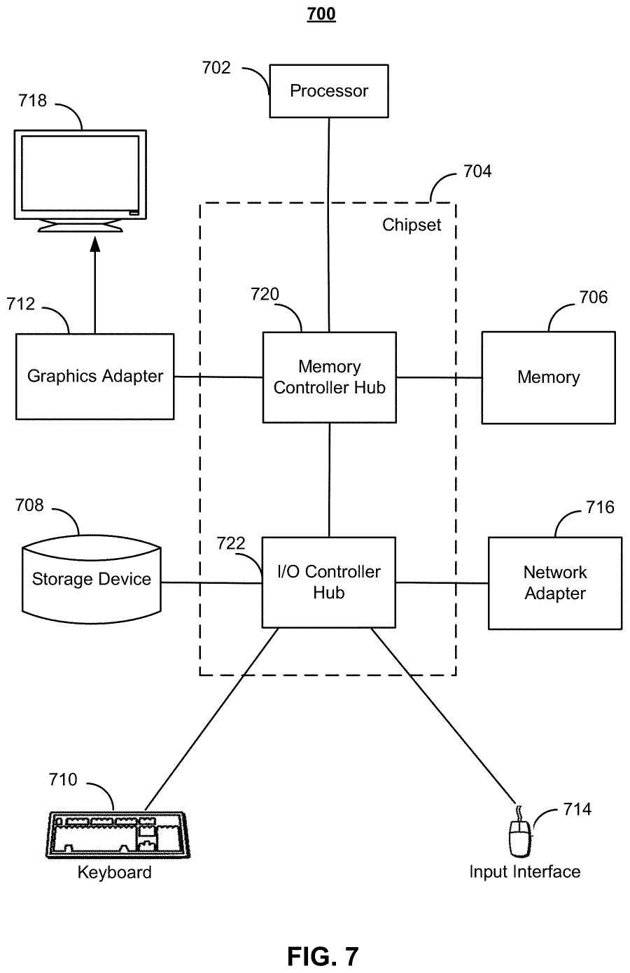

FIG. 7 illustrates an example computing device for implementing the systems and methods described above. In some embodiments, the computing device 700 shown in FIG. 7 includes at least one processor 702 coupled to a chipset 704. The chipset 704 includes a memory controller hub 720 and an input/output (I/O) controller hub 722. A memory 706 and a graphics adapter 712 are coupled to the memory controller hub 720, and a display 718 is coupled to the graphics adapter 712. A storage device 708, an input interface 714, and a network adapter 716 are coupled to the I/O controller hub 722. Other embodiments of the computing device 700 have different architectures.

The storage device 708 is a non-transitory computer-readable storage medium such as a hard drive, compact disk read-only memory (CD-ROM), DVD, or a solid-state memory device. Memory 706 holds instructions and data used by processor 702. The input interface 714 is a touch-screen interface, a mouse, trackball, or other types of input interface, a keyboard 710, or some combination thereof, and is used to input data into the computing device 700. In one example, the chat and generative AI text-based inputs may be received in the input interface 714 (e.g., keyboard 710). In some embodiments, the computing device 700 may be configured to receive input (e.g., commands) from the input interface 714 via gestures from the user. In some embodiments, the computing device 700 may be configured to receive voice input for chat and generative AI voice-based inputs. The graphics adapter 712 displays images, graphs, and other information on the display 718. The network adapter 716 couples the computing device 700 to one or more computer networks.

The computing device 700 is adapted to execute computer program modules for providing the functionality described herein. As used herein, the term “module” refers to computer program logic used to provide the specified functionality. Thus, a module can be implemented in hardware, firmware, and/or software. In one embodiment, program modules are stored on the storage device 708, loaded into memory 706, and executed by processor 702.

The types of computing devices 700 can vary from the embodiments described herein. For example, the computing device 700 can lack some of the components described above, such as graphics adapters 712, input interface 714, and displays 618. In some embodiments, a computing device 700 can include a processor 702 for executing instructions stored on a memory 706.

In some embodiments, a computing device 700 may include one or more cloud servers. In one example, a computing device 700 may be a cloud server sitting in the cloud environment, which includes and/or is representative of a platform for certain services or applications. The platform may abstract the underlying functionality of hardware (e.g., servers) and software resources of the cloud environment. The resources may include applications and/or data that can be utilized while computer processing is executed on servers that are remotely located. Resources can also include services provided over the Internet and/or through a subscriber network, such as a cellular, Bluetooth or Wi-Fi network.

The methods for generating code snippets for content licensing can, in various embodiments, be implemented in hardware or software, or a combination of both. In one embodiment, a non-transitory machine-readable storage medium, such as the one described above, is provided, the medium comprising a data storage material encoded with machine-readable data which, when using a machine programmed with instructions for using said data, is capable of displaying any of the datasets and execution and results of digital asset management of the disclosure. Such data can be used for a variety of purposes, such as digital asset monitoring and metric generation, and the like. Embodiments of the methods described above can be implemented in computer programs executing on programmable computers, comprising a processor, a data storage system (including volatile and non-volatile memory and/or storage elements), a graphics adapter, an input interface, a network adapter, at least one input device, and at least one output device. A display is coupled to the graphics adapter. Program code is applied to input data to perform the functions described above and generate output information. The output information is applied to one or more output devices, in a known fashion. The computer can be, for example, a personal computer, microcomputer, or workstation of conventional design.

Each program can be implemented in a high-level procedural or object-oriented programming language to communicate with a computer system. However, the programs can be implemented in assembly or machine language, if desired. In any case, the language can be compiled or interpreted. Each such computer program is preferably stored on a storage media or device (e.g., ROM or magnetic diskette) readable by a general or special-purpose programmable computer, for configuring and operating the computer when the storage media or device is read by the computer to perform the procedures described herein. The system can also be considered to be implemented as a computer-readable storage medium, configured with a computer program, where the storage medium so configured causes a computer to operate in a specific and predefined manner to perform the functions described herein.

The metadata and databases thereof can be provided in a variety of media to facilitate their use. “Media” refers to a manufacturer that is capable of recording and reproducing the metadata and other data information of the present disclosure. The databases of the present disclosure can be recorded on computer-readable media (e.g., any medium that can be read and accessed directly by a computer). Such media include, but are not limited to: magnetic storage media, such as floppy discs, hard disc storage medium, and magnetic tape; optical storage media such as CD-ROM; electrical storage media such as RAM and ROM; and hybrids of these categories such as magnetic/optical storage media. One of skills in the art can readily appreciate how any of the presently known computer readable mediums can be used to create a manufacture comprising a recording of the present database information. “Recorded” refers to a process for storing information on a computer-readable medium, using any such methods as known in the art. Any convenient data storage structure can be chosen, based on the means used to access the stored information. A variety of data processor programs and formats can be used for storage (e.g., word processing text file, database format, etc.).

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated and described in the figures above. Modules may constitute either software modules (e.g., code embodied on a machine readable medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processors) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, include processor-implemented modules.

One or more processors may also operate to support performance of the relevant operations in a “cloud computing” environment or as a “software-as-a-service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain operations may be distributed among the one or more processors, not only residing within a single machine, but deployed across a number of machines. In some example embodiments, one or more processors or processor-implemented modules may be located in a single geographic location (e.g., within a home environment, an office environment, or a server farm). In other example embodiments, one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that includes a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, the use of the “a” or “an” is employed to describe elements and components of the embodiments herein. This is done merely for convenience and to give a general sense of the claimed invention. This description should be read to include one or at least one and the singular also includes the plural unless it is obvious that it is meant otherwise.

Upon reading this disclosure, those of skill in the art will appreciate still additional alternative structural and functional designs for the system described above. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation, and details of the method and apparatus disclosed herein without departing from the spirit and scope defined in the appended claims.

What is claimed is:

1. A method of generating code snippets to license digital content, the method comprising:
acquiring a digital asset in a software-as-a-service (SaaS) interface;
generating metadata and an access uniform resource locator (URL) for the digital asset;
generating a primary JavaScript object notation (JSON) file to create one or more code snippets in different formats for the digital asset; and activating an abstraction process to automatically generate a truncated embeddable code snippet after detection of a licensing of the digital asset.

2. The method of claim 1, further comprising:
generating one or more code snippets to cause the digital asset to be interactive.

3. The method of claim 2 wherein generating one or more code snippets to cause the digital asset to be interactive comprises:
generating one or more code snippets to cause one or more hotspot icon links to be included in the digital asset.

4. The method of claim 2, wherein generating one or more code snippets to cause the digital asset to be interactive comprises:
generating one or more code snippets to cause an auto-populated ad placement to be included in the digital asset.

5. The method of claim 2, wherein generating one or more code snippets to cause the digital asset to be interactive comprises:
generating one or more code snippets to cause one or more pop-up windows to be included in the digital asset.

6. The method of claim 1, further comprising:
tracking license purchase and placement activities of the digital asset.

7. The method of claim 6, wherein tracking the license purchase and placement activities of the digital asset is implemented in a blockchain.

8. The method of claim 6, further comprising:
generating an engagement score for the digital asset based on the license purchase and placement activities of the digital asset.

9. The method of claim 7, wherein a non-fungible token (NFT) is used to reference the digital asset in the blockchain environment.

10. The method of claim 1, further comprising:
tracking, in a blockchain environment, commerce activities for commerce content included in the digital content.

11. The method of claim 10, further comprising:
generating a commerce score for the digital asset based on the commerce activities.

12. The method of claim 1, wherein the digital asset is acquired through a drag-and-drop upload interface included in the SaaS interface.

13. The method of claim 1, wherein the digital asset is acquired by creating the digital asset using a digital canvas included in the SaaS interface.

14. The method of claim 1, further comprising:
initiating the digital asset in the SaaS interface through an online content registration form.

15. A system for generating code snippets to license digital content, the system comprising:
a processor; and
a memory in communication with the processor and comprising instructions which, when executed by the processor, program the processor to:
acquire a digital asset in a software-as-a-service (SaaS) interface;
generate metadata and an access uniform resource locator (URL) for the digital asset;
generate a primary JavaScript object notation (JSON) file to create one or more code snippets in different formats for the digital asset; and
activate an abstraction process to automatically generate a truncated embeddable code snippet after detection of a licensing of the digital asset.

16. The system of claim 15, wherein the instructions further program the processor to:
generate one or more code snippets to cause the digital asset to be interactive.

17. The system of claim 15, wherein the instructions further program the processor to:
track license purchase and placement activities of the digital asset; and
track commerce activities for commerce content included in the digital content.

18. The system of claim 15, wherein the instructions further program the processor to:
generate one or more of an engagement score or a commerce score based on the license purchase and placement activities and the commerce activities.

19. A computer program product for generating code snippets to license digital content, the computer program product comprising a non-transitory computer readable medium having computer readable program code stored thereon, the computer readable program code configured to:
acquire a digital asset in a software-as-a-service (SaaS) interface;
generate metadata and an access uniform resource locator (URL) for the digital asset;
generate a primary JavaScript object notation (JSON) file to create one or more code snippets in different formats for the digital asset; and
activate an abstraction process to automatically generate a truncated embeddable code snippet after detection of a licensing of the digital asset.

20. The computer program product of claim 19, wherein the computer readable program code is further configured to:
generate one or more code snippets to cause the digital asset to be interactive.
